(19) United States
(12) Patent Application Publication
(10) Pub. No.: US 2014/0355912 A1
(43) Pub. Date: Dec. 4, 2014

(54) ODOR RESISTANT BAG AND FILM

(71) Applicant: Garett F. Fortune, Rocky River, OH (US)

(72) Inventor: Garett F. Fortune, Rocky River, OH (US)

(21) Appl. No.: 14/290,419

(22) Filed: May 29, 2014

Related U.S. Application Data
(60) Provisional application No. 61/828,422, filed on May 29, 2013.

(51) Int. Cl. B32B 27/08; B65D 33/00; B32B 27/32; B32B 27/30; B32B 37/14; B32B 27/34

(52) U.S. Cl. CPC B32B 27/08; B32B 37/144; B32B 27/34; B32B 27/32; B32B 27/306; B65D 33/00; B32B 2307/7248; B32B 2439/06; B32B 2323/046
USPC 383/113; 156/60; 428/475.8; 428/220; 428/213

(57) ABSTRACT

An odor-resistant bag is formed from a multiple layer film that includes at least one structural layer, at least one strength bearing layer, and at least one adhesive layer. The at least one strength bearing layer is generally oriented as an outermost interior or exterior layer for providing strength to the bag and preventing odor-causing particles from leaking from the bag. The at least one strength bearing layer may include polyethylene and can include opaque or pigmented coloring. The at least one structural layer may include nylon and can be formed or located adjacent to the at least one strength bearing layer. The film includes at least one adhesive layer coupling the strength bearing layer to the at least one structural layer. The at least one strength bearing layer may include a vapor barrier comprised of ethylene absorbers for preventing odor vapors from entering/leaving the bag. The at least one adhesive layer may provide adhesion between the multiple layers of the film, as well as impart odor barrier properties.

This application claims the benefit of Provisional Application Ser. No. 61/828,422 which was filed on May 29, 2013. The entire content of that application is incorporated hereinto by reference.

### BACKGROUND

The present exemplary embodiment relates to an odor-suppressing or odor resistant, and potentially disposable, bag formed from a multiple-layer film. It finds particular application in conjunction with waste disposal, and will be described with particular reference thereto. However, it is to be appreciated that the present exemplary embodiment is also amenable to other applications such as a bag for storing food items outdoors to keep them away from animals or for bagging up hunting clothes and other such uses.

Currently, conventional plastic waste bags release odor-causing particles over time. These bags tend to mask odor using fragrances, which dissipate over time. Odors, which may be caused by bacterial growth and/or decomposing products contained in the bag, tend to emerge as the fragrances weaken. The odor-causing particles can leak through permeable surfaces of the bag. These surfaces are made permeable by chemical additives that enhance a decomposition of the bag after it is relocated to a landfill. An improved disposable bag is desired, which prevents the odor-causing particles from leaking and escaping from the interior of the bag.

Odor-preventing films have been developed and have applications in other industries, such as in the packaging and distribution of food. The films have been used to protect foods, such as meats, from being contaminated. However, such films have not been adapted for use in waste disposal applications and, more specifically, in manufacturing disposable bags. Such films have also not been designed to prevent smells from escaping while also being strong enough to withstand animal attacks to the disposable bag.

While conventional films include multiple layers, such multi-layer films generally do not include a layer that functions as a means to conceal the contents inside the packaging. Rather, in the food industry, transparent film is desired so that consumers can view and select the products that they are purchasing. However, in waste disposal, transparent bags are undesirable. Generally, waste products can include personal items and/or sensitive information. A disposable bag is expected to maintain privacy. Therefore, in a multi-layer film employed in a waste disposal bag, an opaque and/or colored film layer is desired for concealing the items contained in the bag.

### BRIEF DESCRIPTION

One embodiment of the present disclosure pertains to an odor barrier bag formed from a multiple layer film. Both disposable and non-disposable uses of such a bag are contemplated. The film includes at least one strength bearing layer, which can be disposed as an outermost layer, and can include at least one structural layer. The strength bearing layer includes opaque or pigmented coloring to conceal the items contained in the bag. The film includes at least one adhesive layer coupling the strength bearing layer to the structural layer. The at least one adhesive layer can be comprised of ethylene-vinyl-alcohol or EVOH, which retards the passage of odor causing particles through the bag. An inside layer includes a vapor barrier for preventing vapors from escaping from the bag.

According to another embodiment of the present disclosure, a multi-layer film for forming an opaque or translucent bag with odor barrier properties comprises a first strength bearing layer, a first structural layer, a first adhesive layer intermediate the first strength bearing layer and the first structural layer, a second structural layer, a second adhesive layer intermediate the first and second structural layers, a second strength bearing layer, and a third adhesive layer intermediate the second structural layer and the second strength bearing layer.

According to yet another embodiment of the present disclosure, a multi-layer film for forming an opaque or translucent bag with odor barrier properties comprises a first strength bearing layer comprised of linear low density polyethylene (LLDPE), a first structural layer comprised of nylon, a first adhesive layer located intermediate the first strength bearing layer and the first structural layer, the first adhesive layer comprised of ethylene-vinyl-alcohol (EVA), a second structural layer comprised of nylon, a second adhesive layer located intermediate the first and second structural layers, the second adhesive layer comprised of ethylene-vinyl-alcohol (EVOH), a second strength bearing layer comprised of LLDPE, and a third adhesive layer located intermediate the second structural layer and the second strength bearing layer, the third adhesive layer comprised of EVA.

According to another embodiment, a method for manufacturing a bag using a multi-layer film comprises forming a first strength bearing layer, forming a first structural layer, coupling the first strength bearing layer to the first structural layer using a first adhesive layer, forming a second adhesive layer, forming a second structural layer, coupling the second adhesive layer to a second structural layer, forming a second strength bearing layer, forming a third adhesive layer, and coupling the second strength bearing layer to the second structural layer using the third adhesive layer to form the multi-layer film bag.

### BRIEF DESCRIPTION OF THE DRAWINGS

FIG. 1 is a perspective view of a rolled up bag and an unfolded bag according to one embodiment of the present disclosure;

FIG. 2 is a schematic cross-sectional view of the bag of FIG. 1 taken along line A-A;

FIG. 3 is a flow-chart describing a method for manufacturing a bag using the multi-layer film illustrated in FIG. 2; and

FIG. 4 is a schematic cross-sectional view of a multi-layer bag according to another embodiment of the present disclosure.

### DETAILED DESCRIPTION

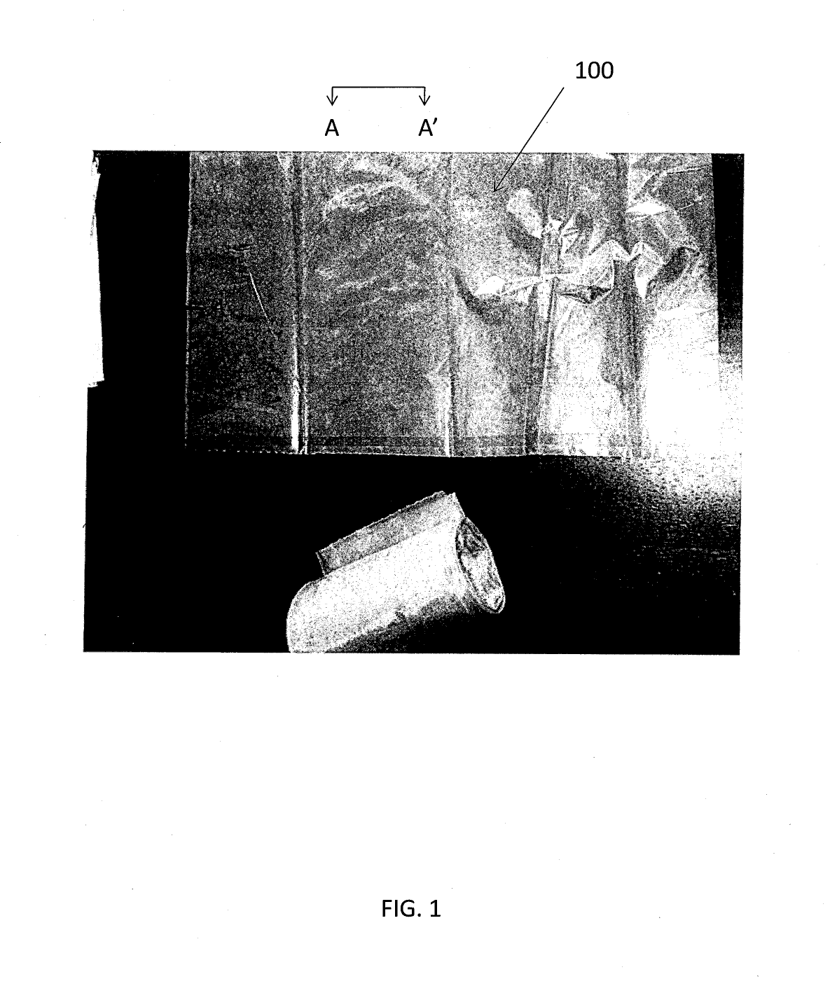

An odorless or odor barrier, opaque bag 100 is shown in FIG. 1. The bag 100 may be a pliable, ‘heavy-duty’ storage bag that may be used to store a number of articles including waste and/or trash. Both disposable and non-disposable uses of the bag are contemplated. The bag 100 in one embodiment is intended for one-time use, i.e., it is disposable. Such a disposable bag 100 is formed from an opaque or colored multi-layer film. In one embodiment, the film is a co-extruded barrier film that is fabricated to include at least one layer formed from polymers. In a preferred embodiment, the polymers are selected from a group consisting of Food and Drug Administration (FDA)-approved plastics for bags contemplated for storing, e.g., food products.

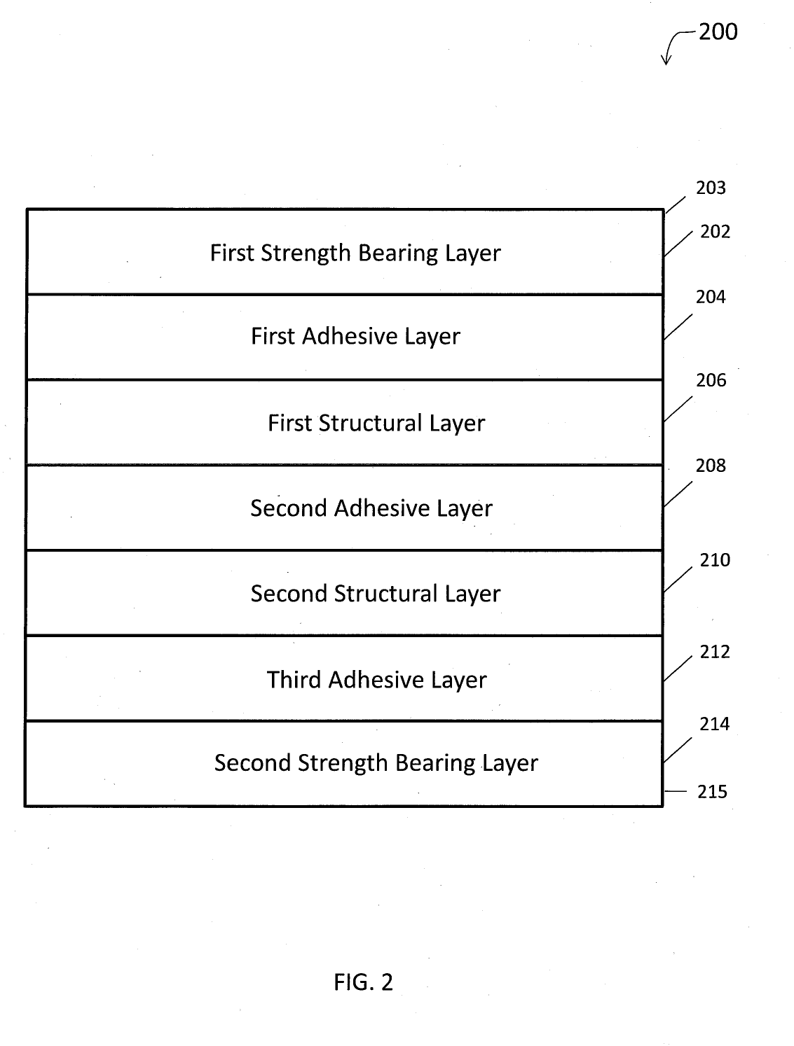

FIG. 2 is a schematic cross-sectional view of a film 200 forming the bag 100 taken along line A-A in FIG. 1. More specifically, FIG. 2 illustrates a multi-layer film formed from a number of co-extruded layers. In the contemplated embodiment, at least two layers are included in the film to provide the desired odor suppressing functionality. In the illustrated embodiment, the film 200 includes seven (7) layers. However, there is no limit made herein to the number of layers. For example, a bag formed from a five-layer film is contemplated as being manufactured from similar materials. What is needed is at least one odor barrier layer which traps odors and at least one strength bearing layer which provides strength to the multiple-ply film, and the bag made from it. Furthermore, there is no limitation made herein to a sequence of the layers providing the desired odor barrier and strength properties. That being said, the embodiments disclosed herein have proven to be particularly desirable in terms of their ability to define multi-layer films that are advantageous for use as bags with the films having the requisite strength, flexibility, odor barrier properties, opaqueness and vapor barrier properties as will be discussed below.

As shown in FIG. 2, one embodiment of the multi-layer film 200 can include a first strength bearing layer 202 (which can be, e.g., polyethylene layer or a similar performing sheet as known to one having ordinary skill in the art), a first adhesive layer 204 (which can be, e.g., ethylene-vinyl-acetate or EVA), a first structural layer 206 (which can be, e.g., nylon or a polyamide or PA), a second adhesive layer 208 (which can be, e.g., ethylene-vinyl-alcohol or EVOH that may also have odor barrier properties), a second structural layer 210 (which can be, e.g., nylon or PA), a third adhesive layer 212 (which can be, e.g., EVA), and a second strength bearing layer 214 (which can be, e.g., polyethene or a similar performing sheet). An opaque and/or pigmented colorant is added to at least one of the first and second polyethylene layers 202, 214. The several layers are adhered together, such as by coextrusion, to a form protective film that prevents the transmission of odor-causing particles or vapors captured inside the bag 100. Also, the entire film 200 may be opaque.

More specifically, the innermost and outermost exposed layers in the illustrated film, as shown in the embodiment of FIG. 2 as first and second strength bearing layers 202, 214, may include polyethylene or a similar performing plastic sheet. In one contemplated embodiment, the first and second strength bearing layers 202, 214 can be formed using a linear low density polyethylene (LLDPE). The polyethylene layers 202, 214 provide strength to the film and the bag made from it. In other words, the polyethylene strength bearing layers 202, 214 adds toughness to the film, thus making a bag formed from the film durable for carrying heavy and/or sharp items.

The first and/or second strength bearing layers 202, 214 may further include a vapor barrier 203, 215 comprising an ethylene absorber. In one embodiment, the first strength bearing layer 202 is an innermost exposed layer of the multi-layered film 100 and is comprised of polyethylene and a vapor barrier 203 including an ethylene absorber. In another embodiment, the first and second strength bearing layers 202, 214 include vapor barriers 203, 215 including ethylene absorbers.

Such ethylene absorbers in the vapor barriers 203, 215 are known products and are available from Next Generation Films of 230 Industrial Drive, Lexington, Ohio 44904, as well as a variety of other vendors.

A colorant can be added to at least one of the layers 202-214. In one embodiment, opaque coloring 216 (e.g., titanium dioxide TᵢO₂) with or without a pigment) is added to at least one of the polyethylene layers in order to conceal the contents of the bag. In the contemplated embodiment, the opaque coloring 216 is added to the outermost first strength bearing layer 202. However, an embodiment is contemplated in which the opaque coloring is added to both strength bearing layers 202, 214. The opaque coloring prevents contents in the bag 100 from being seen. Adding a pigment 218 to the opaque coloring 216 can provide a more pleasing coloring to the bag 100. In one embodiment, this pigment 218 can be of a green color, but there is no limitation as to the color. In another embodiment, the opaque colorant 216 can be added to the outermost exposed second strength bearing layer 214 and the pigment 218 can be added to the inner most exposed first strength bearing layer 202. Furthermore, any one or combination of additives can be added to (or omitted from) a select layer(s) of the film for achieving a desired opaqueness, transparency, and/or tint.

First and second structure layers 206, 210 can be located adjacent to the inside-oriented surfaces of the first and second strength bearing layers 202, 214. These structure layers 206, 210 provide structure to the film 200 and to the later manufactured bag 100, which provide a measure of puncture resistance. The structure layers 206, 210 can also add an odor barrier function to the disposable bag 100. The structure layers 206, 210, may be comprised of nylon, or a similar performing polymer as known to one having ordinary skill in the art.

The second adhesive layer 208 may be comprised of EVOH or similar materials as known to one having ordinary skill in the art. The second adhesive layer 208 adheres the first and second structure layers 206, 210 together and may also function as an odor barrier in the film. Accordingly, the first and second structure layers 206, 210 and second adhesive layer 208 may collectively be considered as “the barrier layers” 206, 208, 210, may prevent odor-causing particles from escaping a closed bag 100. In contemplated embodiments, these odor-causing particles can emanate from, for example, diapers, incontinence products, and decomposing products, such as food, and pet waste, etc. First and third adhesive layers 204 and 212 are used to couple the first and second nylon layers 206, 210 to the polyethylene layers 202, 214.

The term “mil” according to the present application is a unit of length equal to one thousandth (10⁻³) of an inch.

There is no limitation made herein to a thickness of each layer 202-214. In one embodiment, a thickness of each layer 202-214 can range between approximately 1.5 mil to 2.0 mil. For example, layers having thicknesses approximating 1.5, 1.75, and 1.8 mil may be desirable. The various layers 202-214 can have substantially equal thicknesses. In one example, at least of the barrier layers 206, 208, 210 (e.g., nylon and/or EVOH) may comprise approximately 8%-10% of the total thickness of the film.

In the illustrated example of FIG. 2, the barrier layers each comprise approximately 8%-10% of the total thickness of the film 200. Alternatively, some layers can be thicker than other layers. In the illustrated embodiment of FIG. 2, the strength bearing layer(s) (e.g., LLDPE) 202, 214 may be thicker than the barrier layers 206, 208,210. Thicknesses can be selected for the various layers based on manufacturing issues.

According to another embodiment, the various layers may be represented by a percentage of the total thickness of the film 200, e.g., the first strength bearing layer comprises approximately 35%, the first adhesive layer comprises approximately 5%, the first structural layer comprises approximately 8%, the second adhesive layer comprises approximately 5%, the second structural layer comprises approximately 7%, the third adhesive layer comprises approximately 5%, and the second strength bearing layer comprises approximately 35% of the total thickness of the film 200. The total thickness of the film 200 may be between 1.5 mil and 1.8 mil.

A contemplated storage volume of the disposable bag can range from approximately 1 gallon to about 42 gallons. Of course, any desired storage volume could be provided. For example, 2 gallon bags, 13 gallon bags or 42 gallon bags may be desirable. In one embodiment, the bag is manufactured with no perfumes or fragrances added to any of the layers, because odorants are not needed to mask any smells emanating from the bag. Rather, the disposable bag is odorless and the multi-layer film enables the bag to remain odorless by containing all odors in the bag.

The bag can be closed in any number of known ways. For example, integral ties can be provided on the bag. Other ways of closing the bag include the use of clips, twist ties, tape, hand sealers or interlocking fastener structures as are known in the art. Such fastener or closing structures include integral zipper-like sealing closures as are known in the art.

In one embodiment, the film can be formed into pouches with zipper sealed closures. Pouch sizes of 3.5×5″ (8.9×12.7 cm); 6″×6″ (15.2×15.2 cm); and 9″×9″ (22.9×22.9 cm) are contemplated. Of course, other pouch sizes or bag sizes can also be employed.

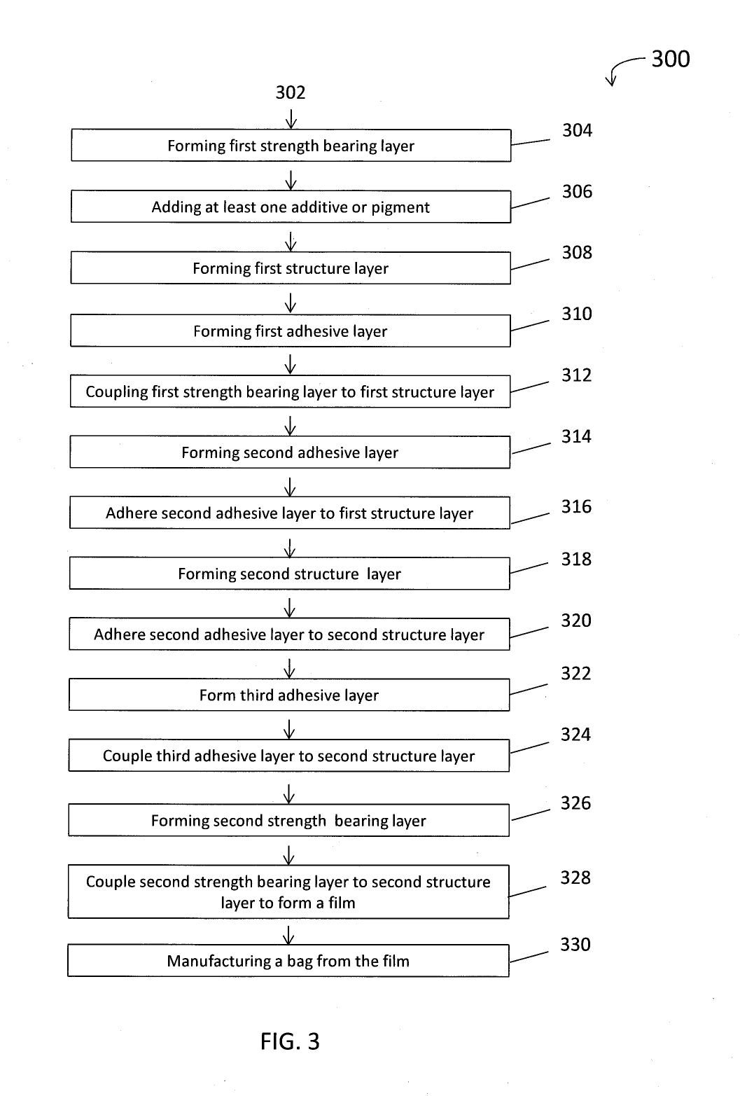

FIG. 3 is a flow-chart describing a method 300 for manufacturing the bag 100 using the multi-layer film 200 illustrated in FIG. 2. The method starts at S302. A first strength bearing layer is formed at S304. At least one of an opaque additive or pigmented colorant may be added to the first strength bearing layer at S306. A first structural layer is formed at S308. A first adhesive layer is formed at S310. The first strength bearing layer is coupled to the first structural layer using a layer of the first adhesive at S312. A second adhesive layer may serve as a combination adhesive and odor barrier layer and is formed at S314. This combination layer is adhered to the opposite surface of the first structural layer at S316. A second structural layer is formed at S318. The combination adhesive/odor barrier layer is coupled to the second structural layer at S320. A third adhesive layer is formed at S322. A layer of the third adhesive is formed on an opposite surface of the second structural layer at S324. A second strength bearing layer is formed at S326. The second strength bearing layer is coupled to the second structural layer using the third adhesive layer at S328 to form the film. A bag is manufactured from the film at S330.

Although the method 300 is illustrated and described above in the form of a series of acts or events, it will be appreciated that the various methods or processes of the present disclosure are not limited by the illustrated ordering of such acts or events. Thus, the layers are generally co-extruded to form the film. Except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined.

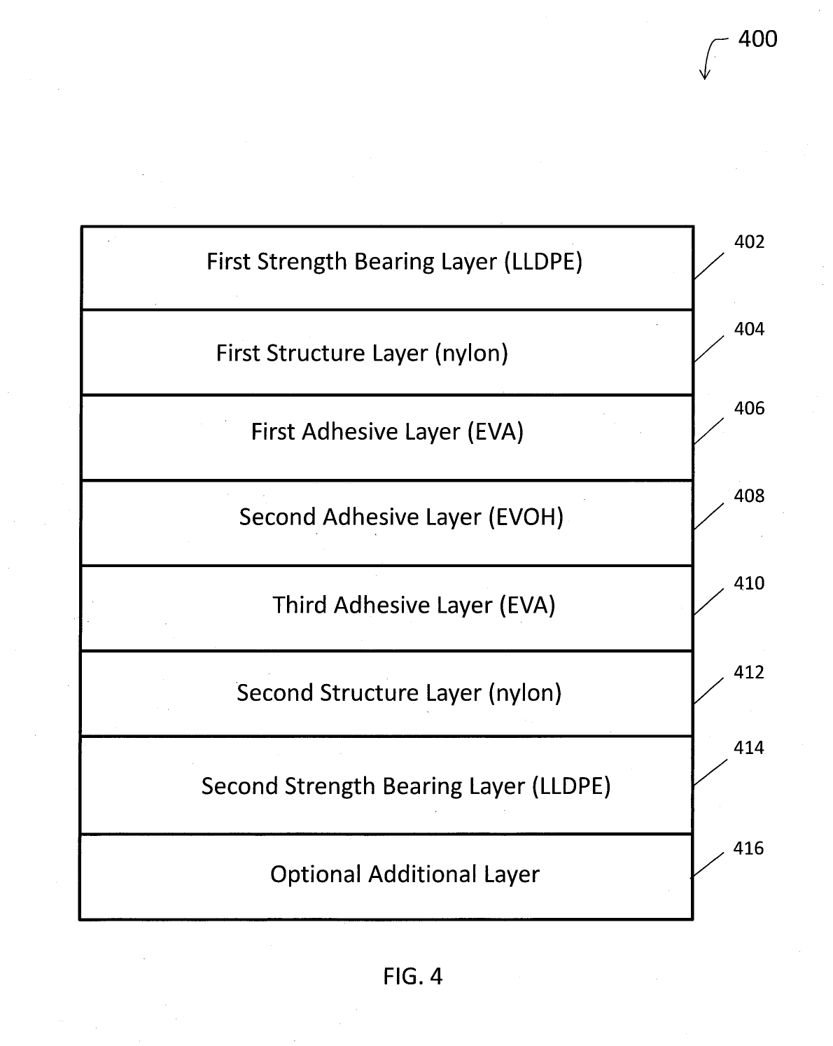

With reference now to FIG. 4, there is disclosed another embodiment of a seven-layer film 400, which is usable for manufacturing bags for holding smelly trash or for securing smells from the outside which may attract animals, i.e., attract bears. In this embodiment of the film 400, two strength bearing layers 402, 414 and three layers of an odor barrier material 406, 408, 410 are included. More particularly, the seven-layer film 400 comprises a first strength bearing layer 402 of LLDPE, a first structural layer 404 of nylon, a first adhesive/barrier layer 406 of EVA, a second adhesive/barrier layer 408 of EVOH, a third adhesive/barrier layer 410 of EVA, a second structural layer 412 of nylon, and a second strength bearing layer 414 of LLDPE.

The LLDPE layers 402, 414 provide strength and toughness for the bag made from the film, and the two nylon layers 404 and 412 provide structure to the bag. The LLDPE layers may additionally include a vapor barrier comprised of ethylene absorbers.

The EVOH layer 408, as well as layers 406 and 410, provide an odor barrier function for the bag. The nylon layers 404 and 412 can provide additional odor barrier function. It should be appreciated that an opaque coloring, a pigment, and any one or combination of additives can also be employed for achieving a desired pigment, opaqueness, transparency, and tint, as in the earlier embodiment. Moreover, additional layers are also contemplated, such as illustrated layer 416. As with the earlier embodiment of FIG. 2, the multiple layers of the film 400 can be coextruded.

As mentioned, the various layers are not limited to any particular order. The film may be fabricated from additional or fewer layers and in a sequence that achieves the desired odor barrier and strength properties and preferably also the vapor barrier properties.

One aspect of the disposable bag 100 disclosed herein is that it is manufactured from a film 200, 400 which is devoid of fragrances, additives, powders and/or perfumes that mask odor rather than contain it. The multi-layer film 200, 400 is odorless. The bag includes at least one odor barrier layer (such as layers 206, 208 and 210 or layers 404, 408, and 412) to prevent odors from leaking from and/or escaping the bag. It also includes at least one strength bearing layer (such as layers 202 and 214 or layers 402 and 414).

Another aspect of the bag 100 is that it conceals the contents stored therein. The opaque and/or pigmented coloring 216, 218 ensure that the contents of the bag 100 cannot be seen.

Still another aspect of one embodiment of the bag 100 is that it has vapor barrier properties.

Other uses of the bag can be non-disposable uses. For example, for outdoors, the bag is useful in that it keeps all smell in. Such a bag is advantageous for storing food and similar items and keeping them away from animals by trapping all scents within the bag so that the animals are not able to smell the food or similar items through the bag. Yet another use would be to keep hunting clothes and like items in a bag so that animals are unable to smell human scents on the materials stored in the bag. Further, such a bag may be useful to store smelly hunting clothes or fishing clothes when traveling to or from a hunting or fishing site. Still other uses of such a bag include food storage uses for home or travel.

In another embodiment, known enzymes or the like could be added to one or more layers of the film in order to enhance the biodegradability of the film.

The exemplary embodiments have been described herein. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A multi-layer film for forming an opaque or translucent bag with odor barrier properties, comprising:
a first strength bearing layer;
a first structural layer;
a first adhesive layer located intermediate the first strength bearing layer and the first structural layer;
a second structural layer;
a second adhesive layer located intermediate the first and second structural layers;
a second strength bearing layer; and
a third adhesive layer located intermediate the second structural layer and the second strength bearing layer.

2. An opaque or translucent bag with odor barrier properties formed from the multi-layer film of claim 1.

3. The multi-layer film of claim 1, wherein at least one of the first and second strength bearing layers is comprised of polyethylene.

4. The multi-layer film of claim 1, wherein at least one of the first and second strength bearing layers is comprised of linear low density polyethylene (LLDPE).

5. The multi-layer film of claim 1, wherein at least one of the first and second strength bearing layers includes a vapor barrier comprising an ethylene absorber.

6. The multi-layer film of claim 1, wherein at least one of the first and second structural layers is comprised of nylon.

7. The multi-layer film of claim 1, wherein at least one of the first and second structural layers and the second adhesive layer form an odor barrier layer.

8. The multi-layer film of claim 1, wherein a total thickness of the film is between 1.5 mil and 1.8 mil.

9. The multi-layer film of claim 8, wherein the first strength bearing layer comprises approximately 35%, the first adhesive layer comprises approximately 5%, the first structural layer comprises approximately 8%, the second adhesive layer comprises approximately 5%, the second structural layer comprises approximately 7%, the third adhesive layer comprises approximately 5%, and the second strength bearing layer comprises approximately 35% of the total thickness of the multi-layer film.

10. The multi-layer film of claim 1, wherein the first and third adhesive layers comprise ethylene-vinyl-acetate (EVA).

11. The multi-layer film of claim 1, wherein the second adhesive layer comprises ethylene-vinyl-alcohol (EVOH).

12. The multi-layer film of claim 1, wherein at least one of the first and second strength bearing layers includes an opaque coloring.

13. The multi-layer film of claim 12, wherein at least one of the first and second strength bearing layers includes a colored pigment.

14. A multi-layer film for forming an opaque or translucent bag with odor barrier properties, comprising:
a first strength bearing layer comprised of linear low density polyethylene (LLDPE);
a first structural layer comprised of nylon;
a first adhesive layer located intermediate the first strength bearing layer and the first structural layer, the first adhesive layer comprised of ethylene-vinyl-alcohol (EVA);
a second structural layer comprised of nylon;
a second adhesive layer located intermediate the first and second structural layers, the second adhesive layer comprised of ethylene-vinyl-alcohol (EVOH);
a second strength bearing layer comprised of LLDPE; and
a third adhesive layer located intermediate the second structural layer and the second strength bearing layer, the third adhesive layer comprised of EVA.

15. An opaque or translucent bag with odor barrier properties formed from the multi-layer film of claim 14.

16. The multi-layer film of claim 14, wherein at least one of the first and second strength bearing layers further include a vapor barrier including an ethylene absorber.

17. A method for manufacturing a bag using the multi-layer film, comprising:
forming a first strength bearing layer;
forming a first structural layer;
coupling the first strength bearing layer to the first structural layer using a first adhesive layer;
forming a second adhesive layer;
forming a second structural layer;
coupling the second adhesive layer to the second structural layer;
forming a second strength bearing layer;
forming a third adhesive layer; and
coupling the second strength bearing layer to the second structural layer using the third adhesive layer to form the multi-layer film bag.

18. A opaque or translucent bag with odor barrier properties formed from the method of claim 17.

19. The method of claim 17, wherein the second adhesive layer may serve as a combination adhesive and odor barrier layer.

20. The method of claim 17, further including forming a vapor barrier on at least one of the first and second structural layers.
